(19) United States
(12) Patent Application Publication
(10) Pub. No.: US 2007/0023354 A1
(43) Pub. Date: Feb. 1, 2007

(54) Methods and systems for dispersing ultrafine non-polar particles into a polymer/solvent/non-solvent solution and products formed thereby

(75) Inventor: Keith Solomon, Cheshire, CT (US)

Correspondence Address: 3M INNOVATIVE PROPERTIES COMPANY, PO BOX 33427, ST. PAUL, MN, 55133-3427, US

(73) Assignee: CUNO Incorporated

(21) Appl. No.: 11/189,662

(22) Filed: Jul. 26, 2005

(51) Int. Cl. B01D 71/06

(52) U.S. Cl. 210/500.27; 264/41; 106/31.65; 428/475.5; 96/4

(57) ABSTRACT

A method for producing a homogeneous and stable dispersion of ultrafine non-polar particles in a ternary polymer/solvent/non-solvent solution (dope) suitable for phase inversion formation into a controlled pore size microporous polymer membrane wherein the polymer contains homogeneously distributed ultrafine non-polar particles is disclosed. In one possible embodiment, the ultrafine non-polar particles are ultrasonically dispersed in at lest one portion of the solvent and is then added to the balance of an optionally separately prepared solvent/non-solvent solution. Subsequently, the polymer is added to and dissolved in the solvent/non-solvent/particle dispersion with the resulting solution being cast into a liquid film and subjected to phase inversion processing is disclosed The resulting polymeric microporous membranes containing highly dispersed and homogeneously distributed ultrafine non-polar particles are also disclosed.

### BACKGROUND OF THE DISCLOSURE

The present disclosure is directed to methods and systems for producing a homogeneous and stable dispersion of ultrafine non-polar particles in a ternary polymer/solvent/non-solvent solution (dope) suitable for phase inversion formation into a controlled pore size microporous polymer membrane wherein the polymer contains homogeneously distributed ultrafine non-polar particles and more particularly, to methods and systems for producing a homogeneous and stable dispersion of ultrafine non-polar particles in a ternary polymer/solvent/non-solvent solution (dope) suitable for phase inversion formation into a controlled pore size microporous polymer membrane wherein the ultrafine non-polar particles are ultrasonically dispersed in at least one portion of the solvent and then the at least one portion of the solvent having the particle in liquid dispersion is added to the balance of the optionally separately prepared solvent/non-solvent solution and more particularly, methods and systems for producing a homogeneous and stable dispersion of ultrafine non-polar particles in a ternary polymer/solvent/non-solvent solution (dope) suitable for phase inversion formation into a controlled pore size microporous polymer membrane wherein the polymer contains homogeneously distributed ultrafine non-polar particles wherein subsequently, the polymer is added to and dissolved in the solvent/non-solvent/particle dispersion with the resultant solution being cast into a liquid film and subjected to phase inversion processing to produce a polymeric microporous membranes containing highly disperse and homogeneously distributed ultrafine non-polar particles.

The incorporation of ultrafine non-polar particles into polymeric microporous phase inversion membranes may be beneficial in order to modify the optical properties of such membranes such as color, reflectance, uv absorption, or intrinsic fluorescence. While not necessarily limiting, an approximate maximum average size for particles intended to be dispersed in the polymeric web structure of a microporous polymeric phase inversion membrane would be approximately one order of magnitude smaller that the average pore size of the membrane. Particles significantly larger than this, if used in any significant amount, would probably tend to degrade the mechanical properties of the membrane polymer structure. In practice, this would typically require an average particle size of several hundred nanometers or less. The term “Ultrafine Particles”, as used in this disclosure, is intended to specify particles of this order-of-magnitude size or smaller. Carbon black is an excellent example of such a material.

For example, the use of carbon black, which is both ultrafine and non-polar, to modify the reflectance and intrinsic fluorescence of polymeric microporous membranes is disclosed in U.S. Pat. Nos. 6,734,012 and 6,890,483, the disclosures of which are incorporated to the extent not inconsistent with the present disclosure. To be suitable for use in microarrays, the reduced intrinsic fluorescence and reflectance of the membrane must be uniform when quantified at a point to point distance on the membrane surface of about 50 to about 100 micrometers. In production using the dope preparation process steps disclosed in Examples 2 and 5 of U.S. Pat. No. 6,890,483 wherein the carbon black was added directly into the solvent/non-solvent solution using high shear mixing, it was found that there were substantial variations in the uniformity and homogeneity of the carbon black in the finished membrane that appeared to vary either from one batch of carbon black to another or from one batch of dope to another. This variability manifested itself in visually evident variations, at 100× magnification, in the uniformity and homogeneity of the distribution of the carbon black within the membrane polymer structure. Some lots of raw material would yield a gray membrane exhibiting an acceptable uniform and homogeneous distribution of carbon black within the membrane polymer which would provide for uniform reduction of the intrinsic fluorescence and reflectance when quantified at the about 50 to about 100 micrometer point to point distance. Other lots of raw material would yield membrane with gross mottling which, at times, was so severe as to be obvious upon unaided visual examination and which would give unacceptable variation in the reduction of intrinsic fluorescence and reflectance. This type of outcome was reported in the prior art U.S. Pat. No. 35 6,734,012 Column 20, lines 18-26 “Although the carbon black impregnation was effective in reducing fluorescence, it was noticed under magnification that the dispersion of carbon throughout the structure on a microscopic level was less than perfectly uniform”.

This prior art description of the problem does not propose any methods for solving the problem. An example of such a mottled membrane is shown in FIG. 2. It was hypothesized that this variability was associated with non-uniform dispersion of the carbon black in the dope and/or with subsequent instability of the dispersion that could lead to agglomeration of the particles.

Carbon black is an ultrafine particulate form of industrial carbon produced by thermal cracking or thermal decomposition of a hydrocarbon raw material. Carbon blacks are composed of spherical, semi-graphitic particles ranging in diameter from about 10 to about 100 nanometers and in surface area from about 25 to about 1500 square meters per gram with an essentially non-polar surface chemistry. The carbon black particles fuse together in clusters that form the characteristic units of carbon black called aggregates. Discussion with the carbon black supplier and review of the literature and prior art revealed that unmodified carbon black is an extremely difficult material to disperse. A carbon black is optimally dispersed when it has been separated into discrete primary aggregates. The dispersion process does not break down carbon black aggregates into primary particles because these particles are fused together within the aggregate. The basic unit of carbon black is, therefore, the primary aggregate, not the individual particle.

Our use of the term “particle” in the subsequent disclosure will apply to this primary aggregate.

There have been a number of approaches developed to deal with this problem in the manufacture of inks and paints. These systems are comprised of solvent, a polymer (resin), and the carbon black, and, with the exception of a possible final dilution with additional solvent, the resulting dispersion of these components constitutes the final product. All of these approaches are based upon a combination of (1) the modification of the carbon black surface to improve wettability by the dispersing fluid and/or (2) the use of extremely high mechanical or hydraulic shear.

With the exception of the previously mentioned prior art, there appears to have been no past attempts to disperse carbon black, or any other similar ultrafine non-polar particles, into a ternary polymer/solvent/non-solvent solution of the type useful for phase inversion processing into a polymeric microporous membrane so as to produce such a membrane with such particles, uniformly and homogeneously distributed throughout the polymer structure. When the techniques developed for dispersing carbon black to obtain uniform and stable inks and paints were evaluated for use in the production of the intended membrane, they either didn't work or gave a membrane potentially unsuitable for the intended application, i.e., membrane substrate microarrays suitable for fluorescently labeled diagnostic applications

Thus there is a commercially significant need for methods and systems for producing a well dispersed and stable carbon black containing membrane dope that will result in a polymeric microporous phase inversion membrane having the carbon black particles uniformly distributed throughout the membrane polymer structure so as to give a uniform reduction in the intrinsic fluorescence and reflectance at all points on the membrane, and thus make the membrane suitable for use in high density microarrays.

### SUMMARY OF THE DISCLOSURE

One object of the present disclosure is to provide methods and systems for producing a stable dispersion of carbon black particles in a ternary polymer/solvent/nonsolvent solution (dope) which, when subjected to phase inversion processing, will result in a polymeric microporous phase inversion membrane having the dispersed carbon black particles uniformly and homogeneously distributed throughout the membrane polymer.

Another object of the disclosure is to provide a polymeric microporous phase inversion membrane having carbon black particles uniformly distributed throughout the membrane polymer so as to exhibit essentially homogeneous color, reduction in intrinsic fluorescence and reduction in reflectance suitable for use in microarrays.

In accordance with these and further objects, one representative method for dispersing ultrafine non-polar particles into a polymer/solvent/non-solvent solution capable of being processed into a microporous polymeric phase inversion membrane having a uniform and homogeneous ultrafine non-polar particle distribution throughout the membrane polymer structure, comprising the acts of: providing a solution selected from at least one of the following: at least one solvent; at least one non-solvent; or a mixture of the at least one solvent and the at least one non-solvent; ultrasonically dispersing ultrafine non-polar particles in the selected solution; optionally providing sufficient additional solvent and/or non-solvent; mixing the dispersed particles with the optionally provided solvent/non-solvent; and dissolving a polymer in the solvent/non-solvent/dispersed particle solution such that, when formed into a microporous polymeric phase inversion membrane, the resulting membrane has a uniform and homogeneous ultrafine non-polar particle distribution throughout the polymer structure.

An additional representative embodiment of the present disclosure includes a membrane comprising: a microporous polymeric phase inversion membrane structure; sufficient ultrafine non-polar particles uniformly and homogeneously distributed throughout the membrane structure prepared in accordance with the following method: for dispersing ultrafine non-polar particles into a polymer/solvent/non-solvent solution capable of being processed into a microporous polymeric phase inversion membrane having a uniform and homogeneous ultrafine non-polar particle distribution throughout the membrane polymer structure, comprising the acts of: providing a solution selected from at least one of the following: at least one solvent; at least one non-solvent; or a mixture of the at least one solvent and the at least one non-solvent; ultrasonically dispersing ultrafine non-polar particles in the selected solution; optionally providing sufficient additional solvent and/or non-solvent; mixing the dispersed particles with the optionally provided solvent/non-solvent; and dissolving a polymer in the solvent/non-solvent/dispersed particle solution such that, when formed into a microporous polymeric phase inversion membrane, the resulting membrane has a uniform and homogeneous ultrafine non-polar particle distribution throughout the polymer structure.

One possible additional aspect of the present disclosure includes, but is not limited to, a method for dispersing carbon black particles in a ternary polymer/solvent/non-solvent solution comprising the acts of: initially dispersing the carbon black in a portion of the non-polar solvent used in a ternary solution; recirculating this initial dispersion thru a flow-through ultrasonic unit a sufficient number of cycles such that the dispersion of the carbon black to the level of primary aggregates is achieved; adding the results of the preceding act to a solvent/non-solvent solution separately prepared in which the solvent amount is reduced by the amount of solvent used in preparing the solvent/carbon black dispersion; adding and dissolving a polymer to form the final ternary polymer/solvent/non-solvent/carbon black dispersion.

A further aspect of the present disclosure includes a polymeric microporous membrane, formed by conventional phase inversion processing of the aforementioned carbon black containing ternary solution, wherein the carbon black is uniformly and homogeneously distributed throughout the polymer structure which comprises the microporous membrane.

Other objects and advantages of the invention will be apparent from the following description, the accompanying drawings and the appended claims.

### BRIEF DESCRIPTION OF THE DRAWINGS

FIG. 1 is a photomicrograph at 100× of the surface of a Nylon 6/6 membrane selected as a comparative visual Q.C. standard for the desired carbon black distribution (“A” rating);

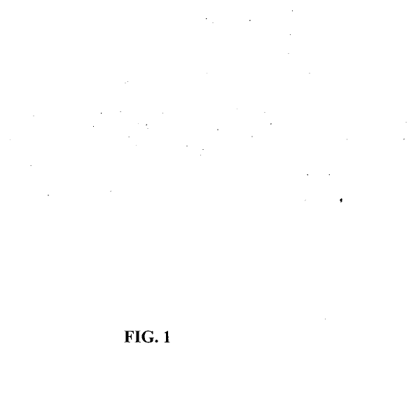

FIG. 2 is a photomicrograph at 100× of the surface of a Nylon 6/6 membrane selected as a comparative visual Q.C. standard for an unacceptable carbon black distribution (“D” Rating);

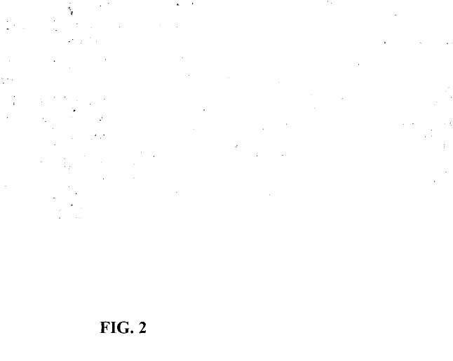

FIG. 3 is a photomicrograph at 100× of the surface of a Nylon 6/6 membrane produced using the methods and materials of prior art U.S. Pat. No. 6,890,483;

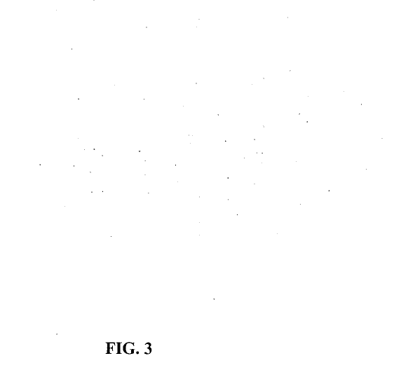

FIG. 4 is a photomicrograph at 100× of the surface of a nylon 6/6 membrane produced using the methods of prior art U.S. Pat. No. 6,890,843 with a highly oxidized carbon black;

FIG. 5 is a photomicrograph at 100× of the surface of a Nylon 6/6 membrane produced by the method of this disclosure; and

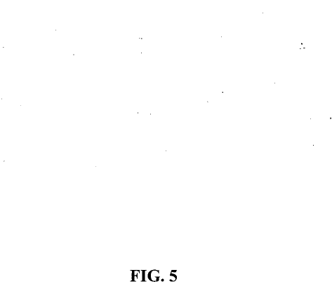

FIG. 6 is a representative schematic of the ultrasonic dispersion system used for the method of this disclosure.

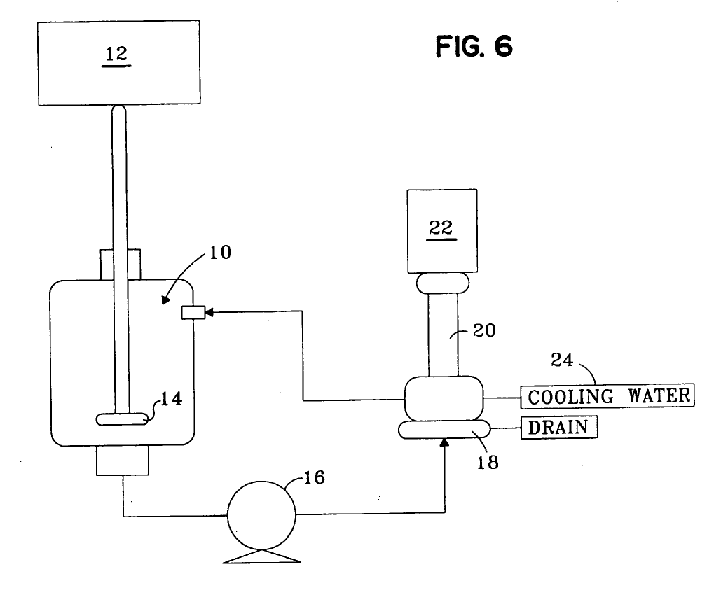

### DETAILED DESCRIPTION OF REPRESENTATIVE EMBODIMENTS

One approach that was considered was the use of carbon black that had been modified by treatment with cationic or anionic surfactants, of the types described in U.S. Pat. Nos. 6,451,100 and 6,780,389, to increase the polarity of the carbon black surface to provide enhanced wettability, which should improve dispersion, and to provide a surface charge on the disperse carbon black particles sufficient to stabilize the resulting dispersion by preventing re-agglomeration. Since the use of membranes in microarrays is dependent upon the specific functional surface chemistry of the membrane polymer surfaces, it was considered inappropriate to introduce any soluble ionic surfactants that could either change this membrane surface chemistry or extract from the membrane to contaminate the various hybridization chemistries that would subsequently be printed onto the membrane to produce the specific microarray.

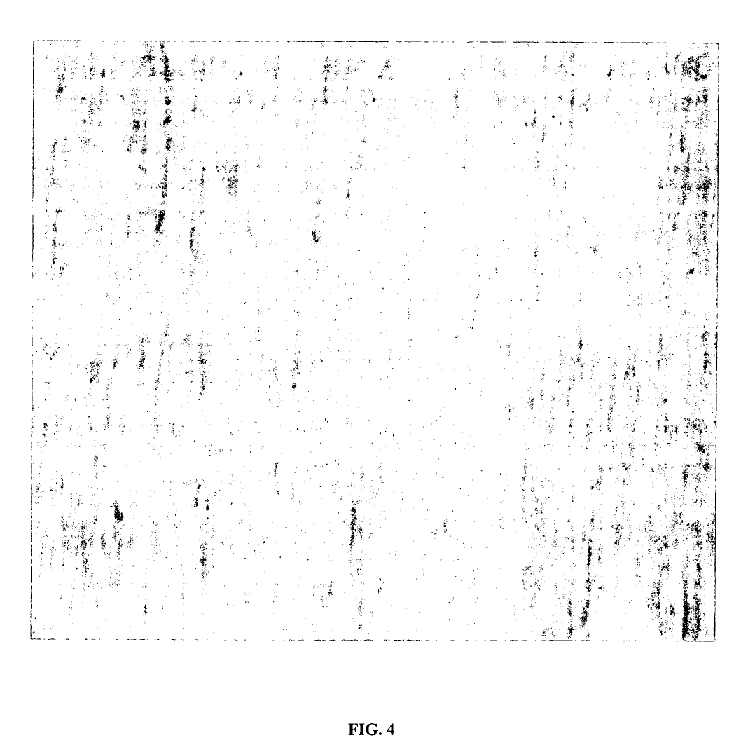

Another similar approach involved the use of carbon black exhibiting higher levels or surface oxidation. It is well known in the art that oxidizing carbon surfaces produces functional surface oxides that increase the polarity of the surface and, therefore, the wettability of the surface by polar fluids. Experiments with such oxidized carbon blacks demonstrate improved dispersion of the carbon black particles in the formic acid, and in the dope prepared using the formic acid/carbon black dispersion, but the resulting membrane exhibited a new form of non-uniform carbon black dispersion described as “mottling” which can be seen at 100× magnification examination as shown in FIG. 4. This mottling was, by far, the worst that had been experienced. It was also noted that significant amounts of the carbon black were partitioning into the quench fluid during the membrane formation step.

It appears that improving the wettability of the carbon black surface is effective in helping to disperse the carbon black particles so as to form a stable carbon black dispersion but that this improved wettability causes these carbon black particles to preferentially associate with the solvent/non-solvent rather than with the Nylon 6/6 polymer. Inasmuch as the phase inversion process involves casting the membrane dope (a ternary solution consisting of a solvent, a soluble polymer, and a miscible non-solvent) into a film and then exposing the cast film to conditions that provide for controlled diffusion of the solvent and non-solvent from the film into the quench fluid, such partitioning will result in a significant amount of the carbon black being lost to the quench fluid. In order for the carbon black particles to remain in the swollen polymer structure and, thus, in the final membrane structure, the particles apparently must exhibit an essentially non-polar surface characteristic so that they will preferentially associate with the polymer. Any surface modification that provides the carbon black aggregates with a polar surface characteristic will result in a significant amount of the wettable carbon black particles ending up in the quenching liquid rather than remaining in the membrane polymer. This significant amount of the wettable carbon black particles ending up in the quenching liquid rather than remaining in the membrane polymer does not occur with the standard carbon black having a nonpolar surface. In addition, the use of this oxidized carbon black gave extreme mottling in the resulting membrane.

In many paint and coating applications involving high viscosity dispersion, ball milling is used to provide the extremely high shear required to adequately disperse the unmodified carbon black. Experiments with this approach demonstrated some effectiveness in achieving an initially high level of dispersion of the carbon black in the formic acid. Unfortunately, this dispersion was unstable and re-agglomeration of the particles occurred fairly rapidly. This, in conjunction with concerns about the contamination of the dope and the resulting membrane with wear products from the milling balls, made this approach unattractive and it was not further pursued as a possible solution to the problem being addressed.

When the present inventor looked harder at the ball milling approach, he recognized that the ball milling approach would probably be effective in its usual application, i.e., in a high viscosity system consisting of a solvent, a dissolved polymer, and the carbon black. The good initial dispersion that was noted would tend to be stabilized by the presence of the polymer and the high viscosity. Theoretically, it should be possible to use some form of a very high shear technique to disperse the carbon black in the finished membrane dope, i.e., the high viscosity polymer/solvent/non-solvent solution. In high shear dispersion processes, much of the energy input is converted to heat and the temperature of dispersant fluid will undergo significant increases. Unfortunately, the pore size of a phase inversion membrane is related to both its dope formulation and its dope temperature history i.e., to the maximum temperature (Tmax) that the dope has experienced during processing. This effect is disclosed in several prior art patents, for example U.S. Pat. No. 6,056,529. The effect of high shear mixing on the pore size of a Nylon 6/6 microporous membrane is well demonstrated in U.S. Pat. No. 4,340,479. It is now understood that the results described in U.S. Pat. No. 4,340,479 probably are the result of the different Tmax achieved at the different mixer speeds. There is no effective way of controlling this latter effect in a ball milling operation or other batch-type high shear mixing techniques because the high temperatures occur at the point of maximum shear, i.e., at the high shear interface between the mixing surface and the dope.

Cooling can be utilized to control the average temperature of the dope but it will not control the Tmax that the dope has experienced and, therefore, control of the resulting pore size would therefore become problematic. For these reasons, ball milling or other high shear dispersion techniques cannot be used be applied to a membrane dope to produce a carbon black filled membrane with a controlled pore size.

The present disclosure provides a method for producing a stable dispersion of carbon black particles in a ternary polymer /solvent /non-solvent solution (dope) which, when subjected to phase inversion processing, will result in a polymeric microporous phase inversion membrane having dispersed carbon black particles uniformly distributed throughout the membrane polymer. The resulting membrane is free from heterogeneous distribution of the carbon black particles and therefore exhibits essentially homogeneous color, reduction in intrinsic fluorescence, and reduction in reflectance. One phase inversion membrane type of particular interest is based on Nylon 6/6 polymer and may use either formic acid/methanol or formic acid/water as the solvent/nonsolvent. It has been discovered by the present inventor that mixing the carbon black with an essentially anhydrous formic acid and subjecting the mixture to high intensity ultrasonics produces a highly dispersed and stable suspension. This stable formic acid/carbon black dispersion is subsequently added to Nylon 6/6 polymer/formic acid solvent/methanol non-solvent solution (dope) using low energy mixing techniques. The formic acid/carbon black mixture is easily dispersed in the dope in the form of a stable homogeneous dispersion. This technique avoids the heating of the dope that would occur if high shear energy mixing was required. The resulting “dope”, when subjected to conventional phase inversion processing, consistently produces a membrane free of mottling when examined at 100× magnification. This freedom from mottling is indicative of both a very high degree of dispersion of the carbon black particles and a very homogeneous distribution of the carbon black particles within the Nylon 6/6 polymer.

Alternately, the formic acid solvent/carbon black dispersion may be added to the formic acid solvent/methanol non-solvent reaction product with the Nylon 6/6 polymer being subsequently dissolved to form the required dope. This approach is equally effective and also avoids the need to impose any high energy mixing on the high viscosity dope.

The carbon black (Degussa Huls Printex U Channel Black) utilized has an essentially non-polar surface chemistry that seems to be required to retain the carbon black in the membrane polymer. In contradiction to the recommendations of the supplier and the teachings of the literature and prior art, this carbon black has neither been modified by oxidation or by surfactant treatment to improve wettability so as to achieve the desired fineness and stability of dispersion. Surprisingly, highly stable dispersions were achieved that give membranes with consistently homogeneous carbon black particle distributions without the use of the aforementioned surface modifications by means of sonification of the formic acid/carbon black mixture. The resulting fluid/particle dispersion appears to exhibit an unexpected non-polar characteristic in that it is does not appear to be miscible in water and does not appear to be dilutable with water even though the formic acid by itself would be expected to dissociate in water.

In other words, the dispersion behaves in an essentially non-polar manner. While not wishing to be bound by this interpretation of these results, it does appear that the essentially anhydrous formic acid behaves as a non-polar fluid that readily wets the non-polar carbon black surface allowing the flow through sonification of the mixture to produce a complete, uniform and stable dispersion, which, in turn, is easily dispersed in a membrane dope separately prepared using conventional low energy mixing means.

When cast into a film and subjected to phase inversion processing, dopes prepared in accordance with the present disclosure result in Nylon 6/6 microporous phase inversion membrane demonstrating consistently uniform grey color with complete freedom from mottling that was not achievable with prior art methods or with state of the art dispersion technology. There appears to be little or no partitioning of the carbon black into the water/formic acid quench fluid used in the phase inversion process, and the carbon black is essentially quantitatively retained in a homogeneous manner throughout the Nylon 6/6 polymer.

It is anticipated that this ultrasonic dispersion method would be equally effective in achieving stable uniform dispersions of carbon black with other polymer/solvent/non-solvent combinations such as those utilized in the production of microporous phase inversion membranes produced from other semicrystalline polymers such as Nylon 6, Nylon 4/6, Nylon Polymer blends,

Polyvinylidendifluoride, Polyethersulfone, and Polysulfone and blends thereof.

### EXAMPLE

About 593 grams of carbon black (Printex U—Degussa Huls) was dissolved in about 20 pounds of about 98 weight percent formic acid in a stainless steel mixing vessel utilizing a high speed rotor-stator mixer (Ross Inc) with a screen mesh head. Mixing was conducted at about 5000 rpm. After about 10 minutes had elapsed, an about 1.5 gpm recirculating pump was used to withdraw the formic acid/carbon black from the bottom of the vessel and to circulate it through a stainless steel flow through vessel with an inserted ultrasonic probe (Hielscher USA Model UIP500). The ultrasonic unit was set to a power level of about 100 percent (approx. 500 Watts). Cooling water at about 20 degree centigrade was flowed through the jacket of the ultrasonic unit, at a rate of about 2 lb/minute, to keep the formic acid/carbon black dispersion cool. At about one hour, the rotor-stator screen head was replaced with a slotted head to compensate for the increasing viscosity of the dispersion. After about four hours, the ultrasonic unit and mixing head were shut off.

Next, a casting dope was prepared using the formic acid/carbon black dispersion prepared as above. About 17 pounds of methanol was added to about 155 pounds of formic acid (98%) in a 20 gallon mixing vessel. The formic acid and methanol, which undergo an esterification reaction, were allowed to react for about 15 minutes which is sufficient for the reaction to run to completion. The about 20 pound formic acid/carbon black dispersion was added and allowed to mix for about 15 minutes. About 32.7 lbs of high amine Nylon 6/6 (Vydyne 6/6B-Solutia Inc) pellets were added and allowed to dissolve for about four hours, to form a “casting dope”.

The resultant dope was then formed into a film on conventional drum casting equipment into a “quench|” solution of methanol and water which resulted in the phase inversion formation of a wet microporous Nylon 6/6 membrane. The resulting wet membrane had a thickness of about 2.0 mils and exhibited a foam-all-over point of about 60 psi in a 60/40 IPA/H2O test solution.

The resulting wet membranes were dried onto epoxy-coated glass slides, measuring 3 inches×2.5 inches, using the process described in U.S. Pat. No. 6,890,483. The resulting composite Nylon 6/6/glass slides were evaluated, in comparison to good and bad lots of prior art production as well as to sample slides produced from the highly oxidized carbon recommended by the supplier, by means of the following tests:

Color—The color (grayness) of the slides were evaluated using a Macbeth Coloreye 3100 Colorimeter. The results are given in terms of the “L” values, with L=100 being pure white and L=0 being total black. Lower L-values (assuming an equivalent amount of carbon black added) indicate a more effective overall dispersion.

Microscopic Visual Examination—slides were placed on a Ram Optical Instruments Automatic Comparator, at 100× magnification. Differences between homogeneous and heterogeneous carbon distributions within the membrane of the various slide samples can readily be characterized from these images using the visual standards (A through F) that had previously been disclosed. A value of “A” indicates a smooth surface free of mottling.

Intrinsic Fluorescence standard deviation slides were placed into an AB1700 reader (Applied Biosystems, Inc.) and imaged for intrinsic fluorescence standard deviation. This algorithm measures the relative variance of dark and white pixels at an emission wavelength of about 658 nm. Lower values indicate less variance across the surface, indicating better dispersion, and correspond with increased signal-to-noise ratios.

In the table below, equivalent amounts of carbon black were added from a “good” lot of Printex U, a “bad” lot of Printex U, an oxidized carbon, and finally a “bad” lot of Printex U with the ultrasonic process. The results of these comparative tests are summarized in the following table:

| | | | Visual | |
|---|---|---|---|---|
| Process | Carbon Black | Color | Rating | Fluorescence |
| Rotor- | GoodPrintex U | 50.8 | A | 95 |
| Stator | | | | |
| Rotor- | Bad Printex U | 56 | C-D | 210 |
| Stator | | | | |
| Ultrasonic | Bad Printex U | 49.2 | A | 96 |
| Rotor- | Oxidized | 65 | F | ˜1000 |
| Stator | | | | |

While the presently preferred representative embodiment has disclosed novel methods and systems that deal with the homogeneous incorporation of carbon black into Nylon 6/6 microporous membrane, those skilled in the arts will readily recognize that this disclosure applies equally well to the homogeneous incorporation of carbon black into the membrane polymer for any polymer system capable of being converted, via a phase inversion system, into a polymeric microporous membrane, such as, for example PVDF and PES. Also, while the presently preferred representative embodiment has disclosed novel methods for the homogeneous incorporation of carbon black into such polymeric microporous membranes, those skilled in the art will recognize that this disclosure applies equally well to the incorporation of any ultrafine particles or nanofibers having a non-polar surface characteristic.

While the articles, apparatus and methods for making the articles contained herein constitute preferred embodiments of the invention, it is to be understood that the invention is not limited to these precise articles, apparatus and methods, and that changes may be made therein without departing from the scope of the invention which is defined in the appended claims.

What is claimed is:

1. A method for dispersing ultrafine non-polar particles into a polymer/solvent/non-solvent solution capable of being processed into a microporous polymeric phase inversion membrane having a uniform and homogeneous ultrafine non-polar particle distribution throughout the membrane polymer structure, comprising the acts of:
providing a solution selected from at least one of the following:
at least one solvent;
at least one non-solvent; or
a mixture of the at least one solvent and the at least one non-solvent;
ultrasonically dispersing ultrafine non-polar particles in the selected solution;
optionally providing sufficient additional solvent and/or non-solvent
mixing the dispersed particles with the optionally provided solvent/non-solvent; and
dissolving a polymer in the solvent/non-solvent/dispersed particle solution such that, when formed into a microporous polymeric phase inversion membrane, the resulting membrane has a uniform and homogeneous ultrafine non-polar particle distribution throughout the polymer structure.

2. The method of claim 1 wherein the ultrasonic dispersion act comprises:
a batch type process.

3. The method of claim 1 wherein the ultrasonic dispersion act comprises:
a flow-through process.

4. The method of claim 1 wherein the polymer is a semicrystalline polymer selected from the group comprising:
Nylon 6/6, Nylon 6, Nylon 4/6, Nylon polymer blends, Polysulfone, Polyethersulfone, or Polyvinylidenedifluoride and blends thereof.

5. The method of claim 1 wherein the ultrafine non-polar particle comprises:
unmodified carbon black.

6. The method of claim 4 wherein the polymer comprises:
Nylon 6/6.

7. The method of claim 6 wherein the solvent comprises formic acid and the non-solvent comprises methanol.

8. The method of claim 6 wherein the solvent comprises formic acid and the non-solvent comprises water.

9. A membrane comprising:
a microporous polymeric phase inversion membrane structure;
sufficient ultrafine non-polar particles uniformly and homogeneously distributed throughout the membrane structure prepared in accordance with the method of claim 1.

10. The microporous polymeric phase inversion membrane of claim 9 wherein the polymer is selected from the group comprising:
Nylon 6/6, Nylon 6, Nylon 4/6, Nylon polymer blends, Polysulfone, Polyethersulfone, or Polyvinylidenedifluoride or blends thereof.

11. The microporous polymeric phase inversion membrane of claim 10 wherein the ultrafine non-polar particles comprise:
carbon black.

12. The microporous polymeric phase inversion membrane of claim 9 wherein the membrane exhibits a uniform and homogeneous ultrafine non-polar particle distribution and freedom from mottling at about 100× magnification.

13. The microporous polymeric phase inversion membrane of claim 12 wherein the polymer comprises:
Nylon 6/6.

14. The method of claim 3 wherein the flow-through process further comprises:
continuous recirculating.

15. A method for dispersing carbon black particles in a ternary polymer/solvent/non-solvent solution comprising the acts of:
initially dispersing the carbon black in a portion of the non-polar solvent used in a ternary solution;
recirculating this initial dispersion thru a flow-through ultrasonic unit a sufficient number of cycles such that the dispersion of the carbon black to the level of primary aggregates is achieved;
adding the results of the preceding act to a solvent/non-solvent solution separately prepared in which the solvent amount is reduced by the amount of solvent used in preparing the solvent/carbon black dispersion;
adding and dissolving a polymer to form the final ternary polymer/solvent/non-solvent/carbon black dispersion.
